(19) United States
(12) Patent Application Publication
(10) Pub. No.: US 2010/0023781 A1
(43) Pub. Date: Jan. 28, 2010

(54) DATA PROCESSING APPARATUS, DATA STORAGE DEVICE, AND DATA PROCESSING METHOD THEREFOR

(76) Inventor: Yasuhiro Nakamoto, Kanagawa-ken (JP)

Correspondence Address: COWAN LIEBOWITZ & LATMAN P.C.;JOHN J TORRENTE, 1133 AVE OF THE AMERICAS, NEW YORK, NY, 10036, US

(21) Appl. No.: 11/755,042

(22) Filed: May 30, 2007

(30) Foreign Application Priority Data
Jun. 1, 2006 (JP) 2006-153987 (PAT.
May 22, 2007 (JP) 2007-135953 (PAT.

(51) Int. Cl. G06F 12/14

(52) U.S. Cl. 713/193

(57) ABSTRACT

A supported encryption and authentication function is inquired of a memory card having a digital data encryption and authentication function. An encryption and authentication function to be applied to digital data is selected based on the inquiry result. The memory card is notified of the selection result, and digital data is transmitted to the memory card.

### BACKGROUND OF THE INVENTION

1. Field of the Invention

The present invention relates to encryption and authentication processing between equipment connected to each other.

2. Description of the Related Art

As an electronic photographing device, there is known a digital camera which converts an optical still image captured through a lens into an electrical signal by a CCD, and stores the electrical signal in a storage medium such as a semiconductor memory. The digital camera records a still image as electrical information. The digital camera can play back a still image on a television receiver, transfer it to a remote place through a communication channel, or transfer it to another device through infrared rays or the like. Further, the digital camera can perform various image processes on a still image.

However, electrical information and digital information innately have a disadvantage, that is, high risk of leaking highly confidential information to the outside because digital data can be easily copied and distributed.

A general technology of ensuring confidentiality of digital data is cryptography. For example, an encryption function (e.g., software program or encryption hardware) can be installed in the digital camera to encrypt digital data in photographing. The combination of the cryptography technology with the certification or authentication technology can implement assurance of integrity of digital data (assurance that no data is altered), confirmation of genuineness (identification of a person who created data), and prevention of spoofing.

Storage medium products with CPUs and hardware functions are also coming onto the market. By providing such a storage medium with an encryption function, and a certification or authentication function, the confidentiality, integrity, and genuineness of digital data can be ensured without installing the encryption function in the digital camera.

An information processing apparatus such as a digital camera having an interface with a storage medium, and a storage medium having the encryption function, and the certification or authentication function can be combined into a system which performs processes such as encryption and authentication on generated digital data and holds the processed data in the storage medium.

However, only a simple combination of the digital camera and storage medium cannot cope with a change of the combination. When the encryption function, and the certification or authentication function is added or changed by adding or changing a storage medium, the digital camera cannot know it, failing to execute encryption and authentication processing appropriate for the digital camera or user. This is a serious problem to the digital camera in which the storage medium is frequently exchanged and added.

### SUMMARY OF THE INVENTION

In one aspect, a data processing apparatus comprising: an inquiry section, arranged to inquire a supported encryption and authentication function of a storage medium having an encryption and authentication section for digital data; a notification section, arranged to select an encryption and authentication function to be applied to digital data based on a result of the inquiry, and notify the storage medium of a result of the selection; and a transmitter, arranged to transmit the digital data and key data to the storage medium.

According to this aspect, information on the encryption and authentication function of a connected storage medium can be acquired dynamically. The encryption and authentication function can be selected based on the acquired information on the encryption and authentication function.

In another aspect, a data processing apparatus comprising: a processor, arranged to perform digital data encryption and authentication processing; a first transmitter, arranged to transmit key data to a storage medium having an encryption and authentication section which performs digital data encryption and authentication processing; an inquiry section, arranged to inquire, of the storage medium, an encryption and authentication function and processing capability of the encryption and authentication section; a selector, arranged to select an encryption and authentication function to be applied to digital data based on an encryption and authentication function of the processor and the encryption and authentication function of the encryption and authentication section that is acquired by the inquiry; a determiner, arranged to compare a processing capability of the processor with the processing capability of the encryption and authentication section that is acquired by the inquiry, and determine which of the processor and the encryption and authentication section performs the digital data encryption and authentication processing; and a second transmitter, arranged to transmit digital data having undergone the encryption and authentication processing by the processor to the storage medium or transmit a notification of the selected encryption and authentication function and digital data not subjected to the encryption and authentication processing to the storage medium so as to cause the encryption and authentication section to perform the digital data encryption and authentication processing.

In another aspect, a data storage device having a digital data encryption and authentication function, comprising: a notification section, arranged to notify an external device of a supported encryption and authentication function in response to an inquiry from the external device; a processor, arranged to perform encryption and authentication processing on digital data from the external device by using key data from the external device in accordance with selection by the external device in response to the notification; and a memory, arranged to store the processed digital data and the key data in correspondence with each other.

In another aspect, a data storage device having a digital data encryption and authentication function, comprising: a determiner, arranged to determine a device which has performed encryption and authentication processing on digital data, read of which from a memory is designated by an external device; a processor, arranged to, when the device which has performed the encryption and authentication processing is the data storage device, read out the designated digital data and key data corresponding to the digital data from the memory, and decrypt and verify the digital data using the key data; and a transmitter, arranged to, when the device which has performed the encryption and authentication processing is the data storage device, transmit the digital data decrypted and verified by the processor to the external device, or when the device which has performed the encryption and authentication processing is the external device, read out the designated digital data from the memory and transmit the designated digital data to the external device.

Further features of the present invention will become apparent from the following description of exemplary embodiments with reference to the attached drawings.

### BRIEF DESCRIPTION OF THE DRAWINGS

FIG. 1 is a block diagram showing the arrangement of an information processing apparatus according to the first embodiment;

FIG. 2 is a block diagram showing the arrangement of a storage medium having an encryption and authentication function;

FIG. 3 is a flowchart for explaining encryption and authentication information sharing procedures, and encryption and authentication function selection procedures;

FIG. 4 is a table showing an example of an encryption and authentication function list;

FIG. 5 is a table showing an example of a partial list generated by an encryption and authentication function control unit;

FIG. 6 is a table showing an example of a function selected by a storage medium control unit from the partial list shown in FIG. 5;

FIGS. 7A and 7B are flowcharts for explaining encryption and authentication processing;

FIGS. 8A and 8B are flowcharts for explaining encryption and authentication processing according to the second embodiment;

FIG. 9 is a table showing an example of a partial list received by a camera from a storage medium according to the second embodiment;

FIG. 10 is a table showing an example of the selection result of the camera upon reception of the partial list in FIG. 9;

FIG. 11 is a block diagram showing the arrangement of an information processing apparatus according to the third embodiment;

FIG. 12 is a flowchart for explaining encryption and authentication information sharing procedures, and encryption and authentication function selection procedures;

FIGS. 13A and 13B are flowcharts for explaining encryption and authentication processing;

FIG. 14 is a table for explaining the processing capability of the encryption function of an encryption and authentication unit;

FIG. 15 is a block diagram showing the arrangement of an information processing apparatus according to the fourth embodiment;

FIG. 16 is a block diagram showing the arrangement of a storage medium (storage medium B) according to the fourth embodiment;

FIGS. 17A and 17B are flowcharts for explaining automatic key selection processing according to the fourth embodiment;

FIG. 18 is a table showing an example of a key information list according to the fourth embodiment;

FIGS. 19A and 19B are flowcharts for explaining encryption and authentication processing according to the fourth embodiment;

FIG. 20 is a table showing an example of a correspondence table held in a memory by a storage medium;

FIG. 21 is a table showing an example of a table held in a memory by a camera; and

FIGS. 22A and 22B are flowcharts for explaining a digital data read operation after encryption and authentication processing according to the fifth embodiment.

### DESCRIPTION OF THE EMBODIMENTS

Information processing according to exemplary embodiments of the present invention will be described in detail below.

### First Embodiment

### Information Processing Apparatus

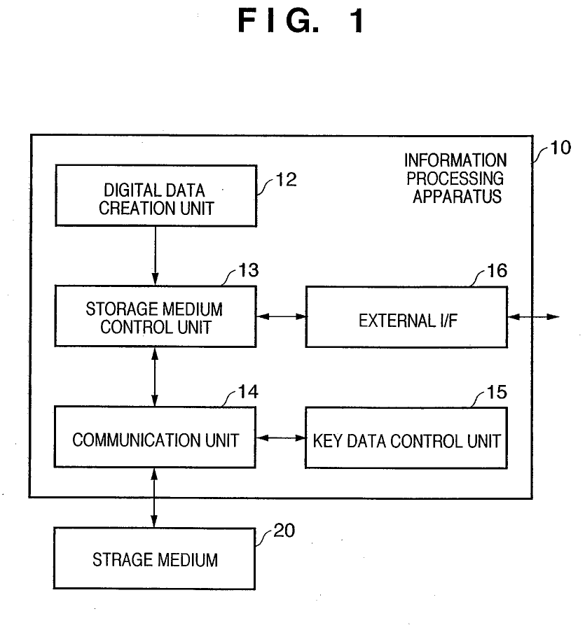

FIG. 1 is a block diagram showing the arrangement of an information processing apparatus 10 according to the first embodiment.

A digital data creation unit 12 creates digital data requiring encryption and authentication processing. A storage medium control unit 13 selects and controls an encryption and authentication function supported by a storage medium 20. In encryption and authentication processing, the storage medium control unit 13 controls data which is input from the digital data creation unit 12 or an external interface (I/F) 16 and output to the storage medium 20 via a communication unit 14.

The communication unit 14 which communicates with the storage medium 20 corresponds to a memory card reader/writer having a memory card slot when the storage medium 20 is a memory card, and a USB (Universal Serial Bus) interface having a USB connector when the storage medium 20 is a USB memory. One storage medium 20 is connected (or mounted) to the information processing apparatus 10 in FIG. 1, but two or more storage media 20 are also connectable (or mountable).

A key data control unit 15 performs a series of control operations to transmit key data received by the external I/F 16 to the communication unit 14. The external I/F 16 is an interface between the information processing apparatus 10 and the user of the information processing apparatus 10. For example, when the information processing apparatus 10 is a digital camera, the external I/F 16 is an operation unit having buttons and a display accessory to the digital camera, a serial bus interface such as IEEE1394, or a wired, wireless, or infrared communication interface.

The information processing apparatus 10 may be an image input device such as a digital camera or scanner which generates image data as digital data, or an electronic device such as a personal computer (PC) capable of generating and editing digital data. For descriptive convenience, the information processing apparatus 10 will be explained as a digital camera (to be simply referred to as a camera hereinafter).

[Storage Medium]

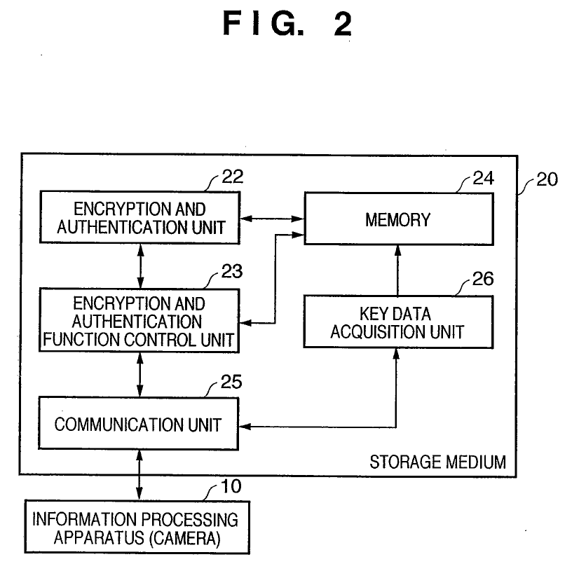

FIG. 2 is a block diagram showing the arrangement of the storage medium 20 having an encryption and authentication function.

An encryption and authentication unit 22 is formed from software or hardware such as an encryption and authentication processing LSI. The encryption and authentication unit 22 encrypts and authenticates digital data received from the camera 10.

An encryption and authentication function control unit 23 provides the camera 10 with information representing an encryption and authentication function supported by the encryption and authentication unit 22. The encryption and authentication function control unit 23 controls the encryption and authentication unit 22 and key data held in a memory 24 in encrypting and authenticating digital data.

The memory 24 stores, for example, encrypted/authenticated digital data, key data received from the camera 10, and information representing an encryption and authentication function supported by the encryption and authentication unit 22. The key data is held in a memory area where only the encryption and authentication unit 22 can read out the key data, and other units cannot read it out (or it is difficult to read it out).

A communication unit 25 is a communication interface corresponding to the communication unit 14 of the camera 10. A key data acquisition unit 26 requests, of the camera 10, key data for use by the encryption and authentication unit 22.

The storage medium 20 suffices to be a memory card, USB memory, or the like having the encryption and authentication function. For descriptive convenience, the storage medium 20 will be explained as a memory card.

[Sharing of Encryption and Authentication Information]

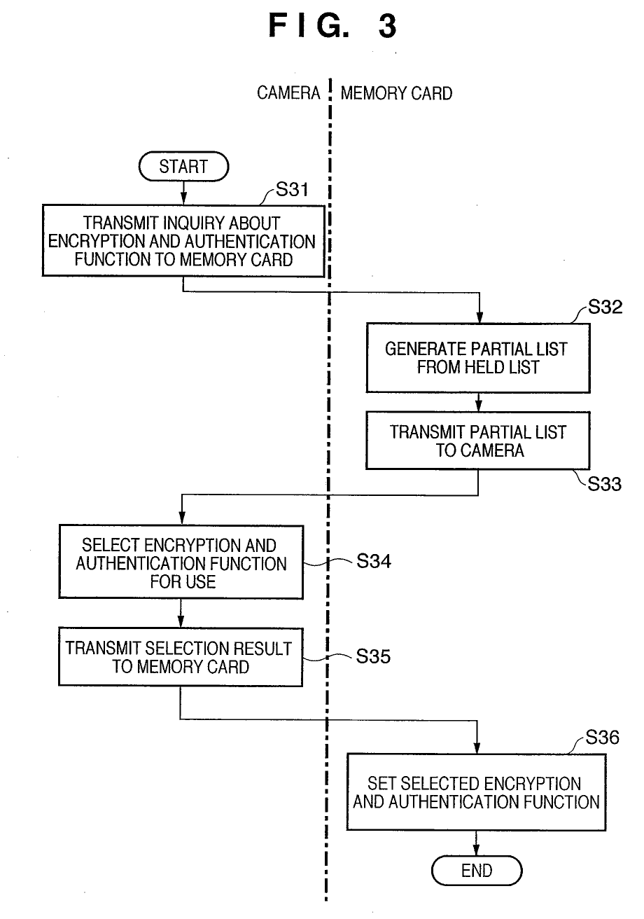

FIG. 3 is a flowchart for explaining encryption and authentication information sharing procedures, and encryption and authentication function selection procedures.

The storage medium control unit 13 of the camera 10 inquires an encryption and authentication function supported by the memory card 20 via the communication unit 14 (S31). Assume that the inquiry format is shared in advance between the camera 10 and the memory card 20. If an encryption and authentication unit, the security level of the encryption and authentication function, performance, and the like necessary for the camera 10 are requested, the storage medium control unit 13 can transmit these pieces of information as requested specifications together with the inquiry. Details of the requested specifications will be described later.

Upon reception of the inquiry via the communication unit 25, the encryption and authentication function control unit 23 of the memory card 20 generates a partial list to be transmitted to the storage medium control unit 13 from an encryption and authentication function list held in advance in the memory 24 (S32). The encryption and authentication function control unit 23 transmits the partial list to the camera 10 via the communication unit 25 (S33).

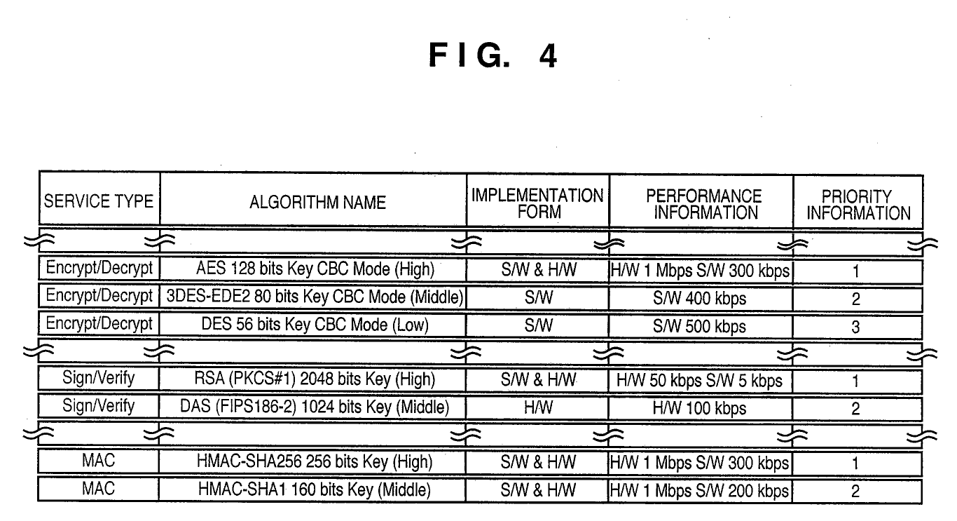

FIG. 4 is a table showing an example of the encryption and authentication function list.

The service type field represents the service system (encryption function, sign function, and the like). The algorithm name field represents concrete function contents such as “AES (Advanced Encryption Standard), 128-bit key used, execute in CBC mode”. The implementation form field represents software (S/W) or hardware (H/W) which implements a function. The performance information field represents functional performance such as a processing speed of 1 Mbps.

Functions registered in the encryption and authentication function list are prioritized in advance for each service type. In the first embodiment, encryption and authentication functions in high ranks in the list have high priorities.

For example, as for the service type “Encrypt/Decrypt”, the AES/128 bits key/CBC mode is higher in priority than the 3DES-EDE2/80 bits key/CBC mode. The default priority is determined in consideration of the security level and performance of each encryption and authentication function.

The security level is expressed by one of three levels “high”, “middle”, and “low” parenthesized in the algorithm name field in FIG. 4. FIG. 4 shows an example of ranking the security of the AES/128 bits key/CBC mode as “high”, that of the 3DES-EDE2/80 bits key/CBC mode as “middle”, and that of the DES/56 bits key/CBC mode as “low”. The evaluation criterion may consider, for example, algorithms recommended by public organizations such as NIST and CRYPTREC (reference: NIST Special Publication 800-57 Recommendation on Key Management) and a general trend. In addition to these criteria, the evaluation criterion also reflects the subjective criterion of a vendor who supplies the memory card 20.

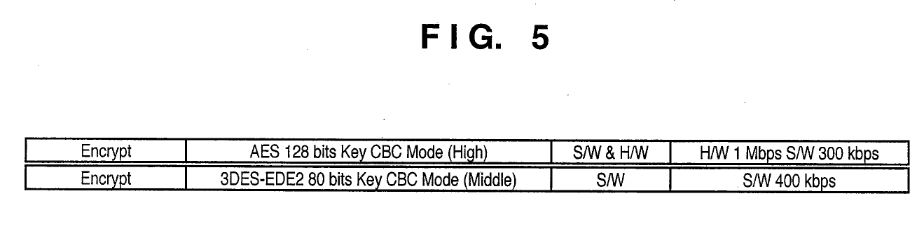

FIG. 5 is a table showing an example of a partial list generated by the encryption and authentication function control unit 23. This example corresponds to a case in which requested specifications “encryption, security level=high or middle, performance≧100 kbps” are designated in step S31. If the term of requested specifications is null, the encryption and authentication function control unit 23 sends back the entire list shown in FIG. 4 as a partial list to the camera 10. If the encryption and authentication function list does not have any function which meets requested specifications, the encryption and authentication function control unit 23 sends back “not available (N/A)” to the camera 10. The partial list sent back from the encryption and authentication function control unit 23 to the camera 10 is a partial list of functions arranged in the order of priority.

As another method of representing priority, priority information may also be added. For example, priority information “1” is added to the AES/128 bits key/CBC mode, and priority information “2” is added to the 3DES-EDE2/80 bits key/CBC mode, as shown in FIG. 4. Priority is given to a function of a smaller numerical value (higher priority).

The storage medium control unit 13 of the camera 10 selects an encryption and authentication function for use in digital data processing from the partial list which is received from the memory card 20 and represents available encryption and authentication functions (S34). In general, a function of the highest priority is selected as a default, but there are exceptions.

Assume that HMAC-SHA1 is presented as a function of the highest priority for the alteration detection function. As for SHA1, security problems have been pointed out these days (reference: Finding Collision in the Full SHA-1, CRYPTO 2005). For this reason, the user or vendor of the camera 10 may reject selection of HMAC-SHA1. When the user or vendor designates exclusion of a specific encryption and authentication function, this function is not selected. Functions to be excluded are designated by the user via the external I/F 16 of the camera 10 before executing step S31 or in executing step S34, or by the vendor in shipping the camera 10.

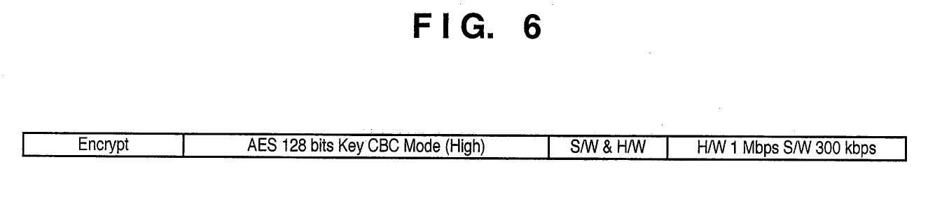

The storage medium control unit 13 of the camera 10 transmits the function selection result to the memory card 20 (S35). FIG. 6 is a table showing an example of a function selected by the storage medium control unit 13 from the partial list shown in FIG. 5. In the example of FIG. 6, the AES/128 bits key/CBC mode of the highest priority in the partial list shown in FIG. 5 is selected. If the selection result is “not available (N/A)”, the storage medium control unit 13 notifies the memory card 20 of a message to this effect.

Upon reception of the selection result, the encryption and authentication function control unit 23 of the memory card 20 sets the operation of the encryption and authentication unit 22 to the selected encryption and authentication function, and enables the encryption and authentication unit 22 (S36).

The processing shown in FIG. 3 is executed at least once when the memory card 20 is connected (or mounted) to the camera 10 or immediately before encryption and authentication processing (to be described below) is performed upon connection. The processing shown in FIG. 3 is executed a plurality of number of times only in a case in which the camera 10 executes step S31 again in order to, for example, change an encryption and authentication function for use.

[Encryption and Authentication Processing]

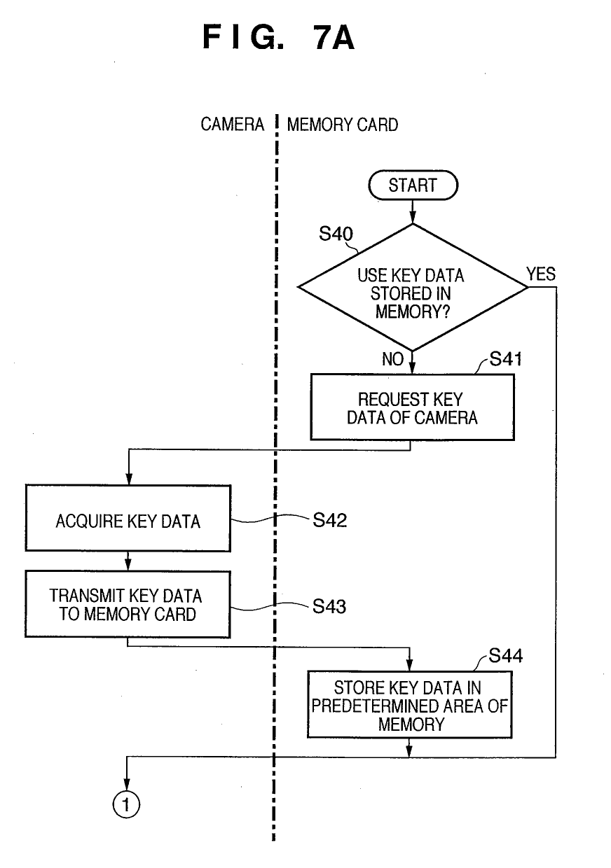

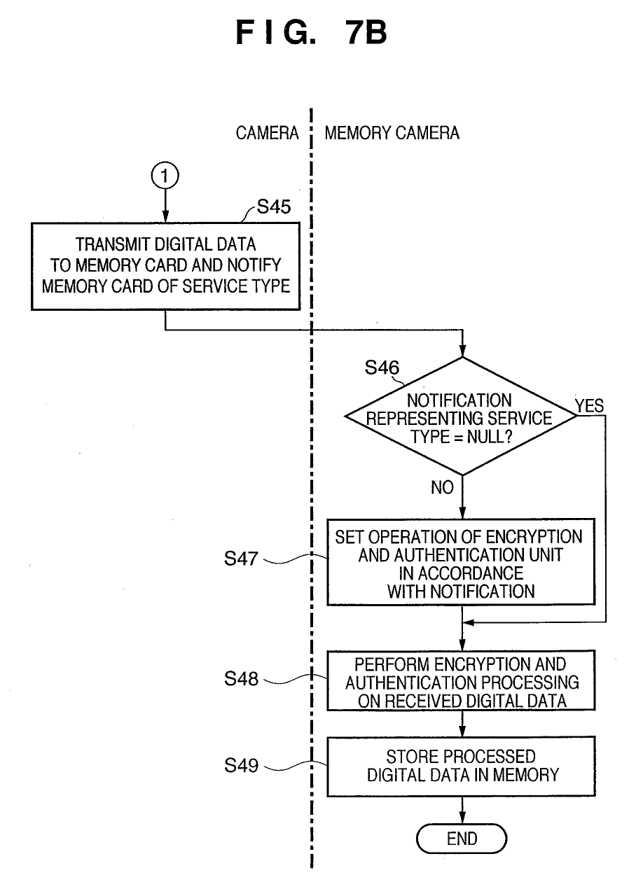

FIGS. 7A and 7B are flowcharts for explaining encryption and authentication processing.

The key data acquisition unit 26 of the memory card 20 requests key data necessary for encryption and authentication processing of the camera 10 via the communication unit 25 (S41). Upon reception of this request, the key data control unit 15 of the camera 10 requests key data of the user of the camera 10 via the external I/F 16 to acquire key data (S42). Then, the key data control unit 15 transmits the acquired key data to the memory card 20 via the communication unit 14 (S43). The user desirably manages key data in security. For example, the user may manage the key by encrypting it with a key encryption means such as PKCS#12 or KeyWrap. When the external I/F 16 is a communication interface, the user desirably secures the security of a communication channel using SSL (Secure Socket Layer) or SSH (Secure SHell).

The key data acquisition unit 26 of the memory card 20 stores the received key data in the memory 24 (S44). At this time, the key data is stored in a memory area of the memory 24 where only the encryption and authentication unit 22 can read out the key data.

Processes in steps S41 to S44 suffice to be done only once as initialization processing before encryption and authentication processing by the memory card 20. Before executing step S41, the key data acquisition unit 26 of the memory card 20 determines whether to use key data already stored in the memory 24 (S40). When the stored key data is to be used, the processes in steps to S41 to S44 are skipped.

The storage medium control unit 13 of the camera 10 transmits digital data generated by the digital data generation unit 12 to the memory card 20. The storage medium control unit 13 notifies the memory card 20 of an encryption and authentication function (service type) applied to the digital data (S45). In this case, the storage medium control unit 13 announces only the service type because encryption and authentication information has already been shared by the above-described sharing of encryption and authentication information. The service type is announced on the assumption that the processing algorithm changes for each digital data. When using an encryption and authentication function (default encryption and authentication function) selected in sharing encryption and authentication information, no service type need be announced. When the same encryption and authentication function is repetitively executed for successive digital data as in sequential shooting, no service type need be repetitively announced for the second and subsequent digital data even in the use of an encryption and authentication function other than a default one.

Upon reception of the digital data, the encryption and authentication function control unit 23 of the memory card 20 determines whether it has been notified of the service type together with the digital data (S46). If the encryption and authentication function control unit 23 has been notified of the service type, it sets the operation of the encryption and authentication unit 22 to an encryption and authentication function corresponding to the notified service type (S47). If the notification is Null, the encryption and authentication function control unit 23 need not set again the operation of the encryption and authentication unit 22 because a default encryption and authentication function is adopted.

The encryption and authentication function control unit 23 encrypts and authenticates the received digital data using the encryption and authentication unit 22 and the key data stored in the memory 24 (S48), and stores the processed digital data in a predetermined area of the memory 24 (S49). The processed digital data and the key data used for processing are stored in correspondence with each other.

As described above, the information processing apparatus 10 can grasp (share) the encryption and authentication function of a storage medium by using a simple protocol, and select an encryption and authentication function which is optimal or desired by the user or vendor. The information processing apparatus 10 can process digital data with the selected encryption and authentication function. Even if the storage medium 20 is changed or added to add or delete an encryption and authentication function, the information processing apparatus 10 can easily cope with it.

### Second Embodiment

Information processing according to the second embodiment of the present invention will be described. In the second embodiment, the same reference numerals as those in the first embodiment denote the same parts, and a detailed description thereof will not be repeated.

In the first embodiment, the number of encryption and authentication processes applied to digital data is only one (e.g., only encryption). In the second embodiment, the present invention is applied to the combination of processes such as sign processing+encryption processing.

In the second embodiment, the arrangements of a camera 10 and memory card 20 are the same as those in FIGS. 1 and 2 in the first embodiment. The encryption and authentication information sharing method is also the same as that in FIG. 3 in the first embodiment.

[Encryption and Authentication Processing]

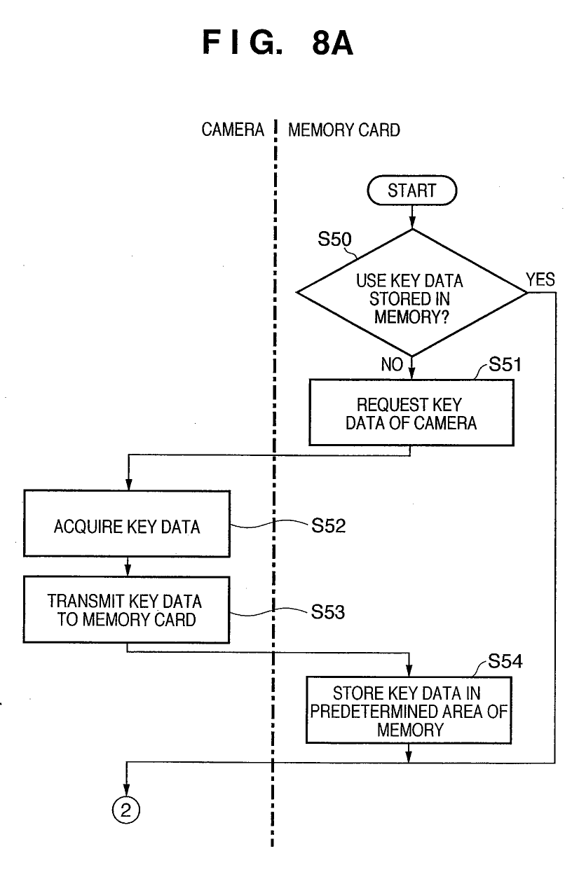

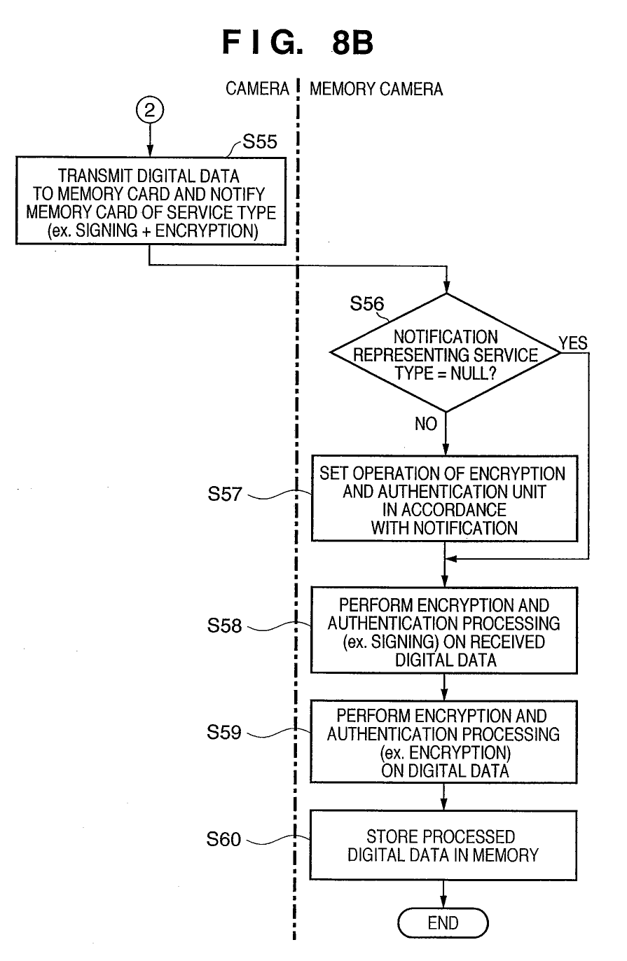

FIGS. 8A and 8B are flowcharts for explaining encryption and authentication processing according to the second embodiment.

A key data acquisition unit 26 of the memory card 20 determines whether to use key data already stored in a memory 24 (S50). If the key data acquisition unit 26 requires new key data, it requests key data necessary for encryption and authentication processing of the camera 10 via a communication unit 25 (S51). Upon reception of this request, a key data control unit 15 of the camera 10 acquires key data via an external I/F 16 (S52). Then, the key data control unit 15 transmits the acquired key data to the memory card 20 via a communication unit 14 (S53). The key data acquisition unit 26 of the memory card 20 stores the received key data in the memory 24 (S54). These processes are the same as steps S40 to S44 in the first embodiment.

A storage medium control unit 13 of the camera 10 transmits digital data generated by a digital data generation unit 12 to the memory card. The storage medium control unit 13 notifies the memory card 20 of an encryption and authentication function (service type) applied to the digital data (S55). In this case, the notified service type is different from that in the first embodiment.

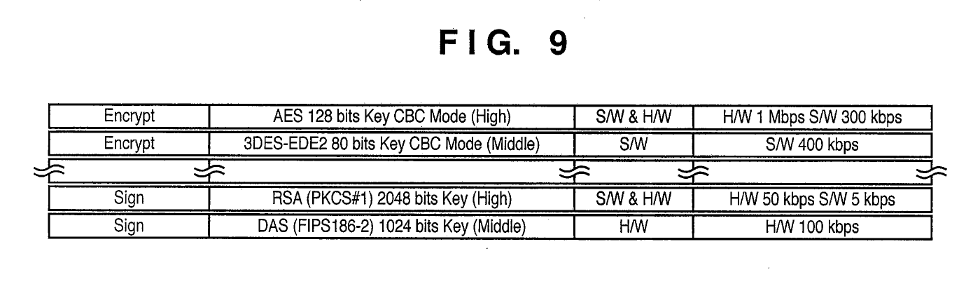

FIG. 9 is a table showing an example of a partial list received by the camera 10 from the memory card 20 according to the second embodiment. Unlike FIG. 5 in the first embodiment, the sign function (Sign) is added to the encryption and authentication function necessary for the camera 10.

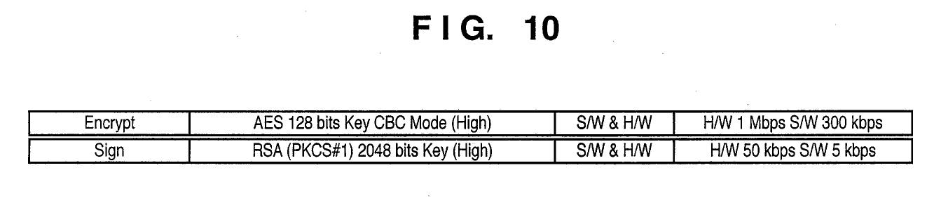

FIG. 10 is a table showing an example of the selection result of the camera 10 upon reception of the partial list in FIG. 9. In this example, the camera 10 selects the AES/128 bits key/CBC mode as the encryption function, and the RSA(PKCS#1)/2048 bits key as the sign function.

As a result, the camera 10 and memory card 20 share encryption and authentication information on the encryption function and sign function. If the user of the camera 10 desires encryption of digital data after adding a digital signature to it, the storage medium control unit 13 may notify the memory card 20 of service types in the order of the sign function and encryption function (S55).

Upon reception of the digital data, the encryption and authentication function control unit 23 of the memory card 20 determines whether it has been notified of the service types together with the digital data (S56). If the encryption and authentication function control unit 23 has been notified of the service types, it sets the operation of an encryption and authentication unit 22 to an encryption and authentication function corresponding to the notified service type (S57). If the notification is Null, the encryption and authentication function control unit 23 need not set again the operation of the encryption and authentication unit 22 because a default encryption and authentication function is employed.

The encryption and authentication function control unit 23 performs encryption and authentication processing (e.g., signing) on the received digital data in accordance with the notification order of service types using the encryption and authentication unit 22 and the key data stored in the memory 24 (S58). Subsequently, the encryption and authentication function control unit 23 performs encryption and authentication processing (e.g., encryption) (S59). The encryption and authentication function control unit 23 stores the processed digital data in a predetermined area of the memory 24 (S60).

In addition to the effects of the first embodiment, the second embodiment can deal with a case in which digital data undergoes the combination of processes such as encryption processing and sign processing. The combination of processes is not limited to encryption processing and sign processing, and three or more processes (e.g., hash processing, sign processing, and encryption processing) may be combined.

### Third Embodiment

Information processing according to the third embodiment of the present invention will be described. In the third embodiment, the same reference numerals as those in the first and second embodiments denote the same parts, and a detailed description thereof will not be repeated.

In the first and second embodiments, only the memory card 20 supports the encryption and authentication function. The third embodiment will explain a method of performing optimal encryption and authentication processing by a camera 10 and memory card 20 in cooperation with each other when the camera 10 also supports the encryption and authentication function.

[Information Processing Apparatus]

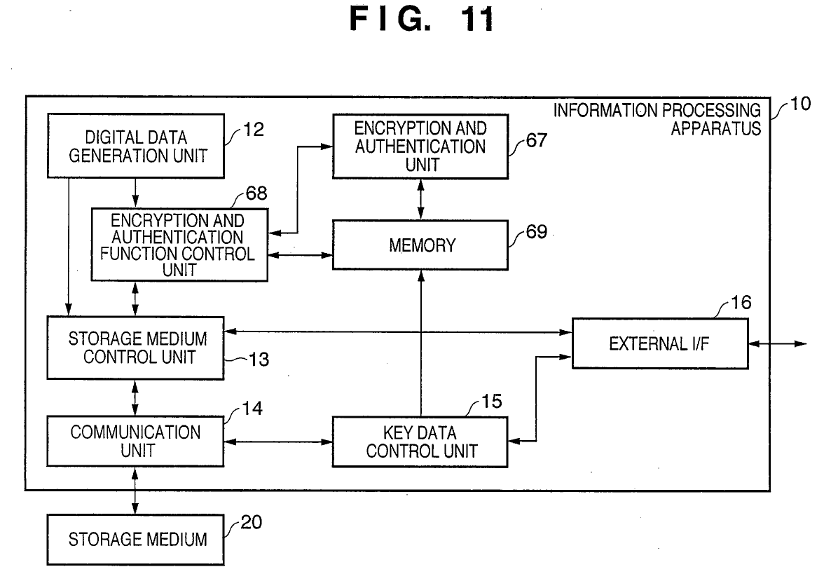

FIG. 11 is a block diagram showing the arrangement of the information processing apparatus (camera) 10 according to the third embodiment.

In addition to the functions described in the first embodiment, a key data control unit 15 stores, in a memory 69, the same key data as that transmitted to the memory card 20. The key data is held in a memory area where only an encryption and authentication unit 67 can read out the key data, and other units cannot read it out (or it is difficult to read it out).

The encryption and authentication unit 67 is formed from software or hardware such as an encryption and authentication processing LSI. The encryption and authentication unit 67 encrypts and authenticates digital data generated by a digital data generation unit 12.

An encryption and authentication function control unit 68 controls the encryption and authentication unit 67 and key data held in the memory 69 in encrypting and authenticating digital data. The encryption and authentication function control unit 68 also has a function of comparing the processing speed of the encryption and authentication unit 67 with that of an encryption and authentication unit 22 of the memory card 20, and properly distributing encryption and authentication processing to the encryption and authentication units 22 and 67.

The memory 69 stores encrypted/authenticated digital data, key data, and information representing encryption and authentication functions supported by the encryption and authentication unit 67 and the encryption and authentication unit 22 of the memory card 20.

The memory card 20 has the same arrangement as that in FIG. 2, and a detailed description thereof will not be repeated.

[Sharing of Encryption and Authentication Information]

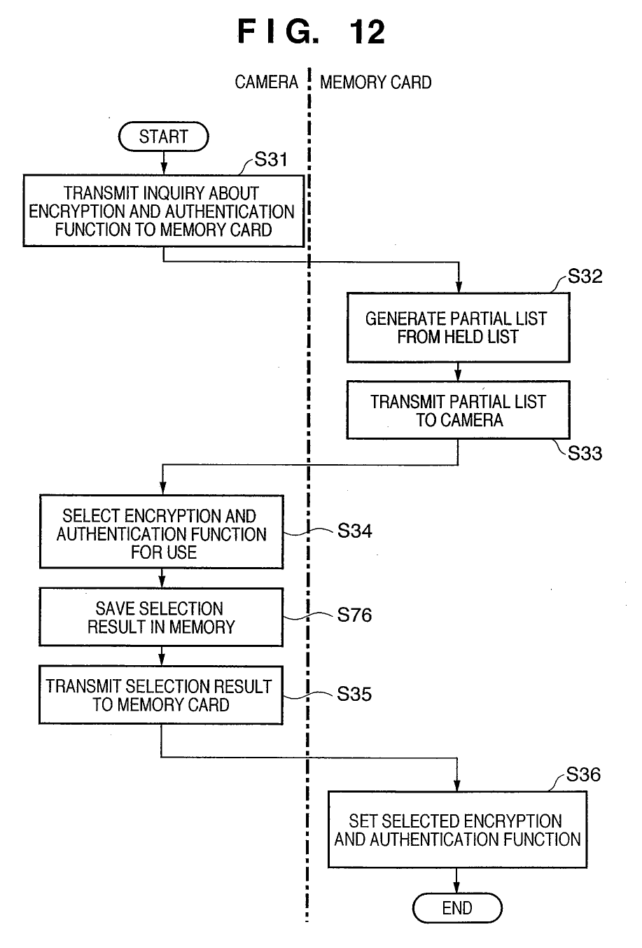

FIG. 12 is a flowchart for explaining encryption and authentication information sharing procedures, and encryption and authentication function selection procedures according to the third embodiment. Unlike the procedures shown in FIG. 3, a storage medium control unit 13 saves an encryption and authentication function selection result (e.g., FIG. 6) in the memory 69 (S76).

[Encryption and Authentication Processing]

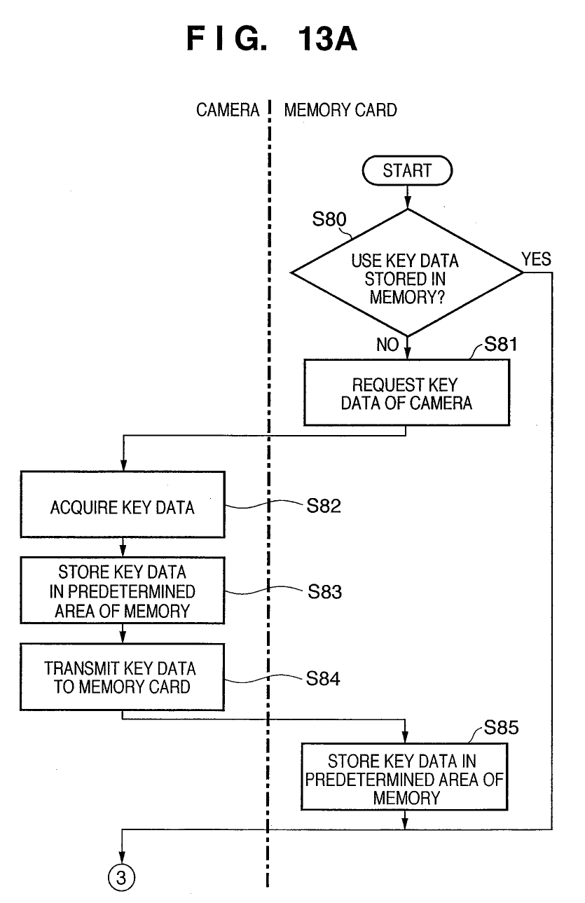

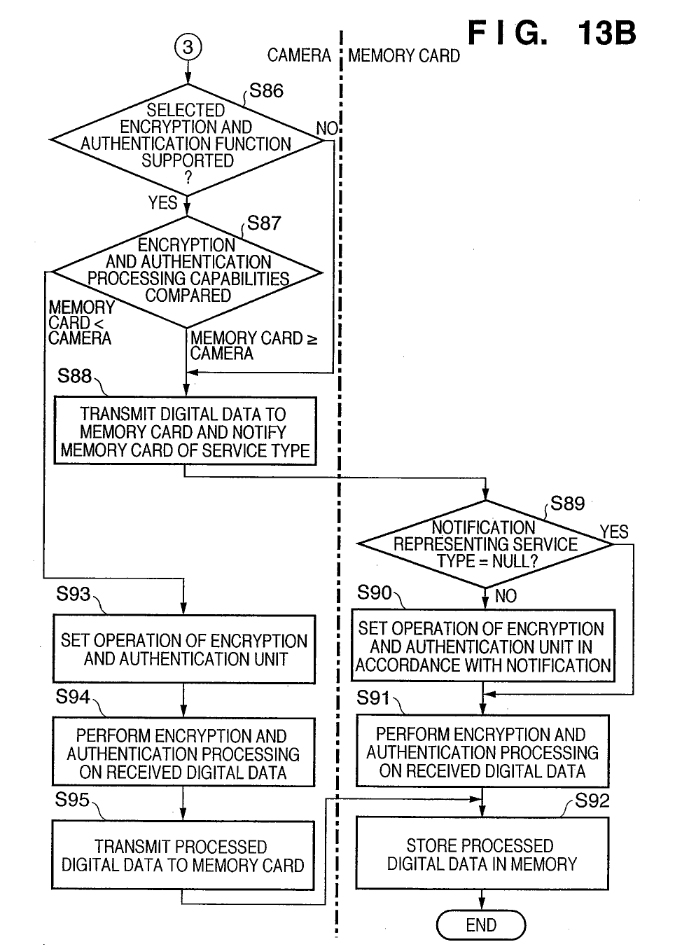

FIGS. 13A and 13B are flowcharts for explaining encryption and authentication processing according to the third embodiment.

A key data acquisition unit 26 of the memory card 20 determines whether to use key data already stored in the memory 24 (S80). If the key data acquisition unit 26 requires new key data, it requests key data necessary for encryption and authentication processing of the camera 10 via a communication unit 25 (S81). Upon reception of this request, the key data control unit 15 of the camera 10 acquires key data via an external I/F 16 (S82). Then, the key data control unit 15 stores the key data in the memory 69 (S83), and transmits it to the memory card 20 via a communication unit 14 (S84). The key data acquisition unit 26 of the memory card 20 stores the received key data in the memory 24 (S85). These processes are the same as steps S40 to S44 in the first embodiment except for step S83.

The encryption and authentication function control unit 68 of the camera 10 refers to encryption and authentication function information of the encryption and authentication unit 67 that is stored in the memory 69, and determines whether the encryption and authentication unit 67 supports the selected encryption and authentication function (S86). If the encryption and authentication unit 67 does not support the selected encryption and authentication function, the process advances to step S88.

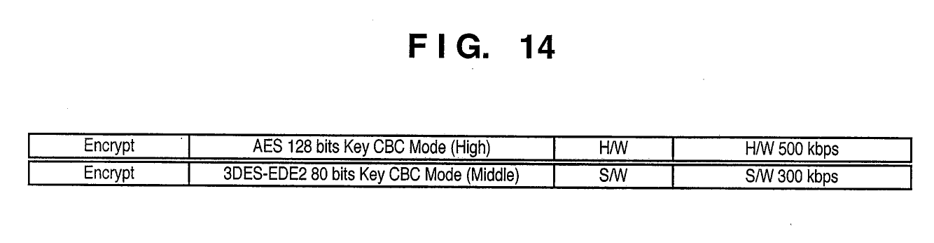

If the encryption and authentication unit 67 supports the selected encryption and authentication function, the encryption and authentication function control unit 68 compares processing capability P1 of the encryption and authentication unit 67 with processing capability P2 of the encryption and authentication unit 22 of the memory card 20 (S87). As the processing capability, for example, the processing speeds of the encryption and authentication units 22 and 67 are compared. Assume that the encryption function shown in FIG. 6 is selected, and processing capability P1 of the encryption function of the encryption and authentication unit 67 has a value shown in FIG. 14. In this case, P1<P2 because processing capability P1 of the encryption and authentication unit 67 is 500 kbps, and processing capability P2 of the encryption and authentication unit 22 is 1 Mbps (by hardware processing).

If the encryption and authentication unit 67 does not support the selected encryption and authentication function, or P1≦P2, the storage medium control unit 13 transmits digital data generated by the digital data generation unit 12 to the memory card 20. The storage medium control unit 13 notifies the memory card 20 of an encryption and authentication function (service type) applied to the digital data (S88).

Upon reception of the digital data, the encryption and authentication function control unit 23 of the memory card 20 determines whether it has been notified of the service type together with the digital data (S89). If the encryption and authentication function control unit 23 has been notified of the service type, it sets the operation of the encryption and authentication unit 22 to an encryption and authentication function corresponding to the notified service type (S90). If the notification is Null, the encryption and authentication function control unit 23 need not set again the operation of the encryption and authentication unit 22 because a default encryption and authentication function is adopted.

The encryption and authentication function control unit 23 encrypts and authenticates the received digital data using the encryption and authentication unit 22 and the key data stored in the memory 24 (S91). The encryption and authentication function control unit 23 stores the processed digital data in a predetermined area of the memory 24 (S92).

If the encryption and authentication unit 67 supports the selected encryption and authentication function, and P1>P2 (the processing capability of the camera 10 is higher than that of the memory card 20), the encryption and authentication function control unit 68 sets the operation of the encryption and authentication unit 67 to the selected encryption and authentication function (S93). The encryption and authentication function control unit 68 encrypts and authenticates the digital data using the encryption and authentication unit 67 and the key data stored in the memory 69 (S94). The encryption and authentication function control unit 68 transmits the processed digital data to the memory card 20 (S95).

Upon reception of the processed digital data, the encryption and authentication function control unit 23 of the memory card 20 stores it in a predetermined area of the memory 24 (S92). If the memory card 20 does not receive any service type notification (including a null notification) from the camera 10, it only stores the received digital data in a predetermined area of the memory 24 (S92).

In the aforementioned example, when the encryption and authentication unit 67 supports a selected encryption and authentication function and P1>P2, the encryption and authentication unit 67 of the camera 10 executes encryption and authentication processing. In general, however, the camera 10 executes processing other than encryption and authentication processing, and cannot always assign a sufficient resource to encryption and authentication processing. To the contrary, the memory card 20 can assign a sufficient resource to encryption and authentication processing. Thus, even if P1>P2, the encryption and authentication unit 22 of the memory card 20 may execute encryption and authentication processing at higher speed. Considering this, for example, if P1>α×P2 (α>1; e.g., α=1.3) including a margin, the encryption and authentication unit 67 of the camera 10 may execute encryption and authentication processing.

In addition to the effects of the first embodiment, when the camera 10 and memory card 20 support the encryption and authentication function, either with higher capability can execute encryption and authentication processing. By combining the second and third embodiments, either with higher capability out of the camera 10 and memory card 20 can execute, for example, the combination of processes.

### Modification of Embodiment

In the third embodiment, the camera 10 selects the encryption and authentication unit 22 of the memory card 20, and the security level and performance of the encryption and authentication function. Alternatively, the user of the camera 10 may make this selection. In this case, the camera 10 prompts the user via the external I/F 16 to make the selection. In accordance with the user's selection, the storage medium control unit 13 of the camera 10 sets (selects) the encryption and authentication unit 22 of the memory card 20, and the security level and performance of the encryption and authentication function.

### Fourth Embodiment

Information processing according to the fourth embodiment of the present invention will be described. In the fourth embodiment, the same reference numerals as those in the first to third embodiments denote the same parts, and a detailed description thereof will not be repeated.

The first to third embodiments assume one memory card 20. However, the present invention is also applicable to a plurality of memory cards 20. For example, encryption and authentication processing is executable by synchronizing a plurality of memory cards having the encryption and authentication function with each other. It is also possible to synchronize a memory card having key data but no encryption and authentication function with a memory card and camera having the encryption and authentication function. As a concrete example of the use, it is conceivable to perform encryption and authentication processing using key data of a memory card serving as a data storage destination, and using the encryption and authentication function of another memory card or the camera. The fourth embodiment will explain a method of performing encryption and authentication processing by a camera 10 using key data of a memory card B 21 and the encryption and authentication function of a memory card A 20.

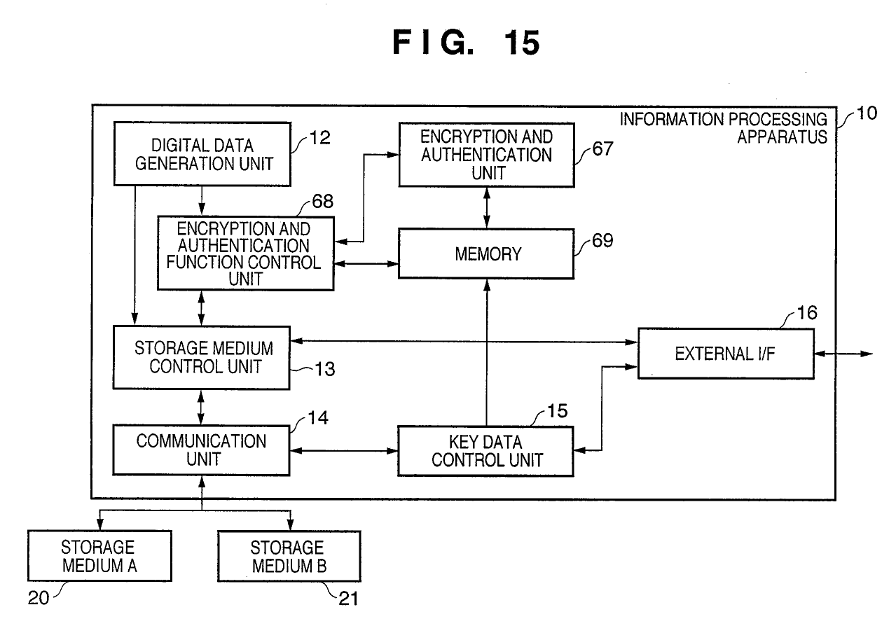

FIG. 15 shows a system configuration according to the fourth embodiment.

[Information Processing Apparatus]

Since the information processing apparatus (camera) 10 in the fourth embodiment has the same arrangement as that in FIG. 11, a detailed description thereof will not be repeated and only a difference from FIG. 11 will be described.

In addition to the functions described in the first embodiment, a storage medium control unit 13 has a function of instructing a given storage medium to transmit key data for use in encryption and authentication processing and encrypted/authenticated digital data to another storage medium or the information processing apparatus.

In addition to the functions described in the first embodiment, a communication unit 14 has an interface capable of connecting a plurality of storage media, as shown in FIG. 15.

In addition to the functions described in the third embodiment, a key data control unit 15 has a function of requesting information on key data held in each storage medium when a plurality of storage media exist.

In addition to the functions described in the third embodiment, an encryption and authentication function control unit 68 has a function of deleting key data received from a storage medium.

[Storage Medium]

Since the storage medium A (memory card A) 20 is identical to the storage medium 20 in FIG. 2, a detailed description thereof will not be repeated and only a difference from FIG. 2 will be described.

In addition to the functions described in the first embodiment, an encryption and authentication function control unit 23 has a function of deleting key data received from another storage medium.

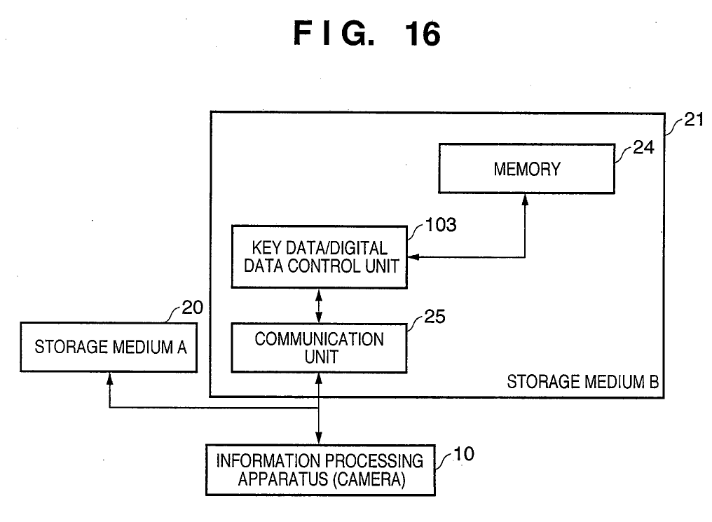

FIG. 16 is a block diagram showing the arrangement of the storage medium B (memory card B) 21.

A key data/digital data control unit 103 performs a series of control operations to transmit key data held in a memory 24 to a communication unit 25. The key data/digital data control unit 103 provides key data information to the camera 10. Also, the key data/digital data control unit 103 stores, in the memory 24, digital data received via the communication unit 25.

The memory 24 and communication unit 25 are identical to those described in the first embodiment, and a detailed description thereof will not be repeated.

[Sharing of Encryption and Authentication Information]

The encryption and authentication information sharing method in the fourth embodiment is the same as that in FIG. 12 in the third embodiment, and a detailed description thereof will not be repeated. In the fourth embodiment, the camera 10 and memory card A 20 share encryption and authentication information.

[Automatic Key Data Selection Processing]

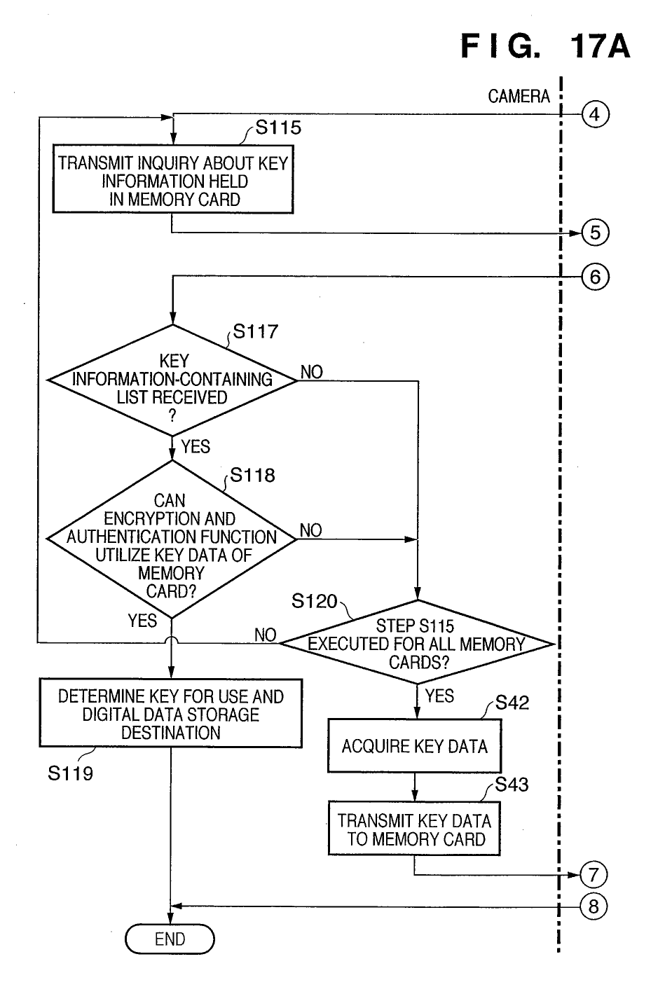

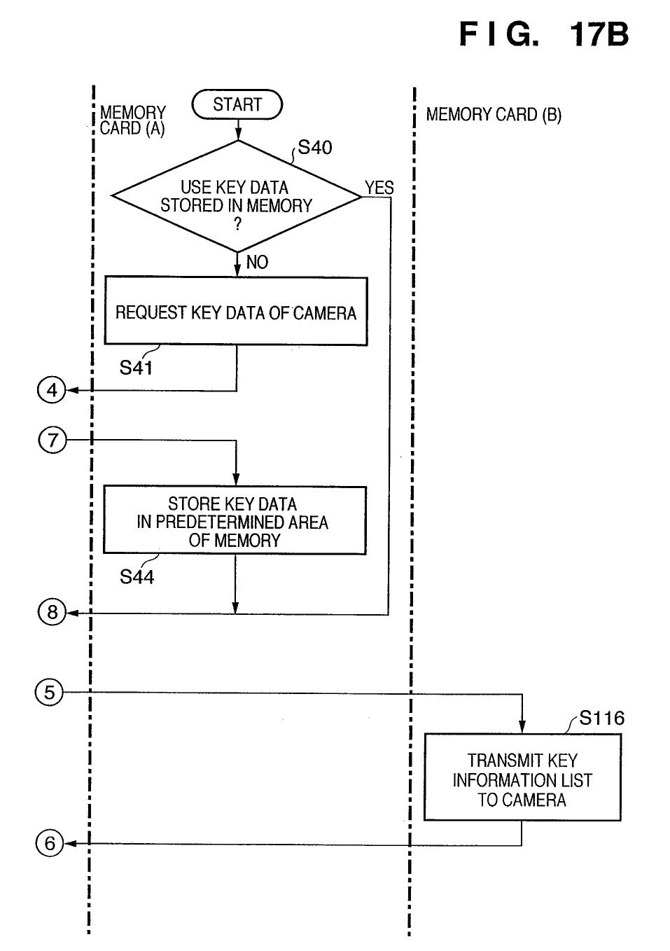

FIGS. 17A and 17B are flowcharts for explaining automatic key data selection processing according to the fourth embodiment.

Processes in steps S41, S42, and S43 are the same as those in the first embodiment.

Upon reception of a key data request from the memory card A 20, the key data control unit 15 of the camera 10 transmits an inquiry about information on key data to the memory card B 21 (S115). Upon reception of the inquiry, the key data/digital data control unit 103 of the memory card B 21 transmits a key information list held in the memory 24 to the camera 10 (S116). If no key information exists, the key data/digital data control unit 103 transmits a blank list.

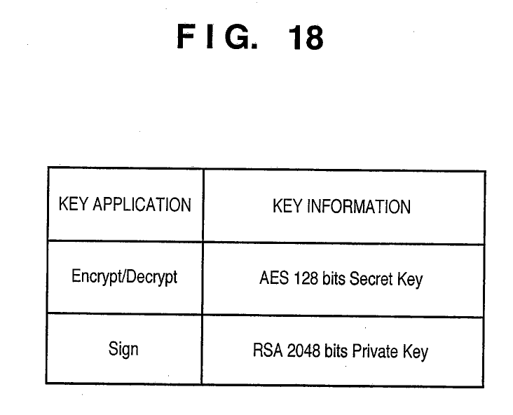

FIG. 18 shows an example of the key information list in the memory card B 21.

The key information field represents information on a key held in the memory card B 21. FIG. 18 shows that the memory card B 21 holds an AES 128 bits key and an RSA 2048 bits key. The key application field represents the application of a key held in the memory card B 21. FIG. 18 shows that the AES128 bits key is applicable to encryption and decryption, and the RSA 2048 bits key is applicable to signing.

The key data control unit 15 of the camera 10 checks the key information list received from the memory card B 21. If the key information list contains key information, the process advances to step S118; if the key information list does not contain any key information, to step S120 (S117). If the key information list contains key information, the storage medium control unit 13 of the camera 10 determines, from an encryption and authentication function selection result stored in a memory 69, whether the encryption and authentication function can utilize key data presented by the key information (S118). More specifically, the storage medium control unit 13 compares the service type field of the encryption and authentication function list with the key application field of the key information list, and the algorithm name field of the encryption and authentication function list with the key information field of the key information list. Assume that the selected encryption and authentication function is one shown in FIG. 6, and the key information list of the memory card B 21 is one shown in FIG. 18. In this case, the key information of the memory card B 21 contains the AES128 bits key applicable to encryption, which is available by the selected encryption and authentication function (Encrypt/AES/128 bits key/CBC mode).

If the encryption and authentication function can utilize the key data presented by the key information (YES in step S118), the storage medium control unit 13 of the camera 10 determines to use the key data, and determines the memory card B 21 holding the key data to be the final storage destination of encrypted/authenticated digital data (S119). In this manner, a memory card which holds key data for use is synchronously determined as the final data storage destination, and the camera need not separately designate the final data storage destination. Since a single memory holds both key data and encrypted/authenticated digital data, key data can be easily acquired to improve convenience in decryption and verification processing.

If no available key information exists in step S117 or the storage medium control unit 13 determines in step S118 that the encryption and authentication function cannot utilize the key data presented by the key information, the storage medium control unit 13 determines whether step S115 has been executed for all memory cards connected to the communication unit 14 of the camera 10 (S120). If the result is YES in step S120, the process advances to step S42; if the result is NO, the process is repeated from step S115 for another memory card.

[Encryption and Authentication Processing]

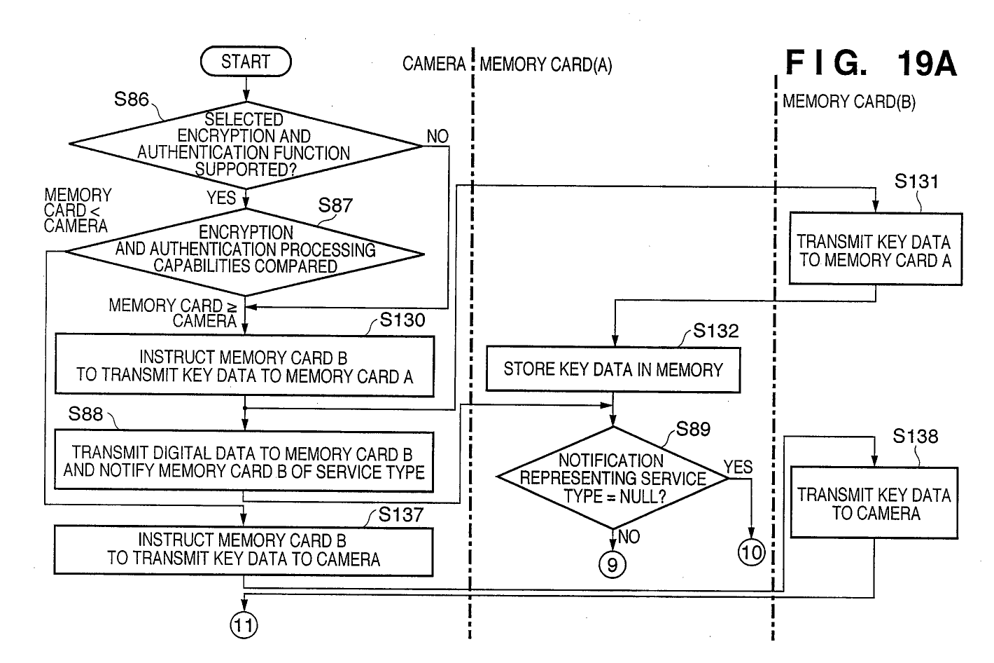

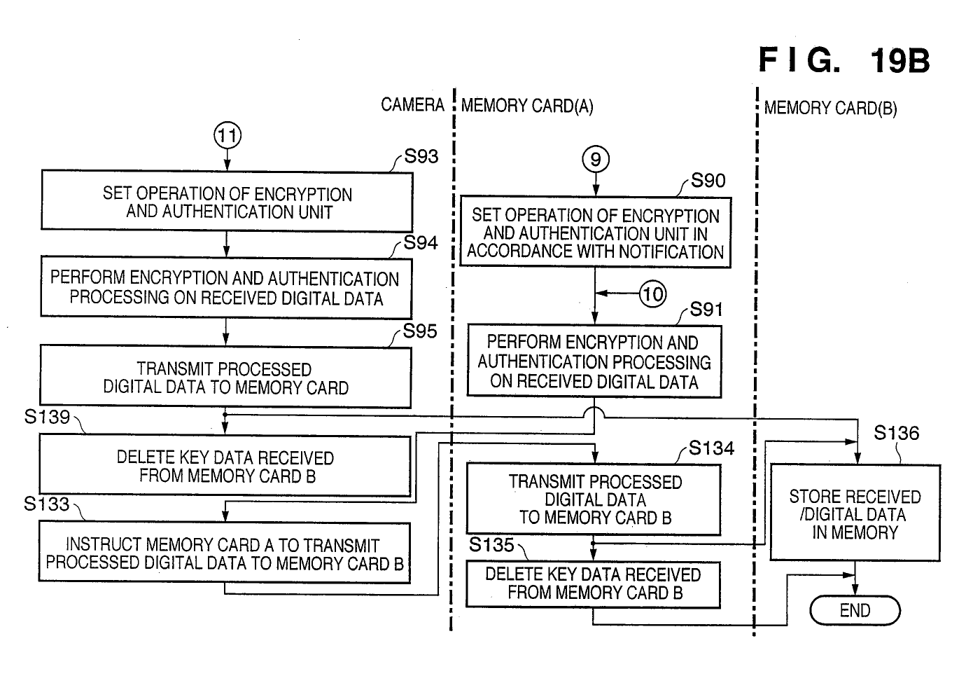

FIGS. 19A and 19B are flowcharts for explaining encryption and authentication processing when the memory card B 21 is selected in step S119 of automatic key data selection processing as a key data use destination and the final storage destination of encrypted/authenticated digital data in encryption and authentication processing.

Processes in steps S86, S87, S88, S89, S90, S91, S93, S94, and S95 in FIG. 19A or 19B are the same as those in FIGS. 13A and 13B in the third embodiment, and a detailed description thereof will not be repeated.

If an encryption and authentication unit 67 of the camera 10 does not support a selected encryption and authentication function, or the processing capability of the camera is less than or equal to the processing capability of the memory card A 20, the storage medium control unit 13 of the camera 10 instructs the memory card B 21 to transmit key data held by it to the memory card A 20 (S130).

The key data/digital data control unit 103 of the memory card B 21 transmits the key data stored in the memory 24 to the memory card A 20 in accordance with the instruction from the storage medium control unit 13 of the camera 10 in step S130 (S131).

The encryption and authentication function control unit 23 of the memory card A 20 stores the key data received from the memory card B 21 in the memory 24 (S132).

The storage medium control unit 13 of the camera 10 instructs the memory card A 20 to transmit processed digital data to the memory card B 21 (S133). The encryption and authentication function control unit 23 of the memory card A 20 transmits the processed digital data to the memory card B 21 (S134). The encryption and authentication function control unit 23 of the memory card A 20 deletes, from the memory 24, the key data received from the memory card B 21 (S135).

The key data/digital data control unit 103 of the memory card B 21 stores the digital data received from the memory card A 20 in the memory 24 (S136).

If the processing capability of the camera is greater than the processing capability of the memory card A 20, the storage medium control unit 13 of the camera 10 instructs the memory card B 21 to transmit key data held by it to the camera 10 (S137).

The key data/digital data control unit 103 of the memory card B 21 transmits the key data stored in the memory 24 to the camera 10 in accordance with the instruction from the storage medium control unit 13 of the camera 10 in step S137 (S138).

The encryption and authentication function control unit 68 of the camera 10 deletes, from the memory 69, the key data received from the memory card B 21 (S139).

### Modification of Embodiment

The fourth embodiment assumes two memory cards 20. However, the present invention can deal with three or more memory cards. The storage medium control unit 13 and encryption and authentication function control unit 68 of the camera 10 share encryption and authentication information and execute automatic key data selection processing for each memory card. As a result, a memory card which is to perform encryption and authentication processing, and a memory card which is to transmit key data and store digital data can be assigned. Encryption and authentication processing can be executed by synchronizing a plurality of memory cards with each other.

The fourth embodiment assumes that the camera 10 and memory card A 20 have the encryption and authentication function. However, the present invention is executable as long as at least one encryption and authentication function is installed. For example, the present invention is executable even in a case in which the camera 10 does not have any encryption and authentication function or the memory card B 21 has the encryption and authentication function.

The camera 10 and a plurality of memory cards can also parallel-execute encryption and authentication processing in the fourth embodiment. This is implemented by distributing a plurality of digital data to the camera 10 and memory cards.

### Fifth Embodiment

Information processing according to the fifth embodiment of the present invention will be described. In the fifth embodiment, the same reference numerals as those in the first to fourth embodiments denote the same parts, and a detailed description thereof will not be repeated.

The first to fourth embodiments have mainly described processing when storing digital data in the memory card 20. The fifth embodiment will explain processing when reading out digital data from a memory card 20.

In step S91 (processing by an encryption and authentication unit 22 of the memory card 20) or step S95 (processing by an encryption and authentication unit 67 of a camera 10) shown in FIG. 13A or 13B, index information on encryption and authentication processing applied to processed digital data is added.

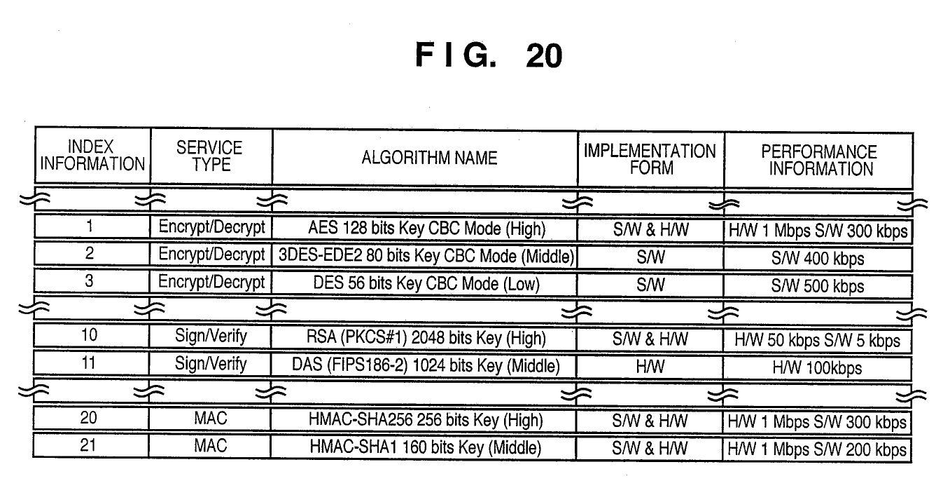

The memory card 20 holds, in a memory 24, a correspondence table of an encryption and authentication function list (see FIG. 4) and index information. FIG. 20 is a table showing an example of the correspondence table held in the memory 24 by the memory card 20. When the memory card 20 executes encryption processing in the AES/128 bits key/CBC mode, an encryption and authentication function control unit 23 adds index information to the processed digital data by looking up the correspondence table.

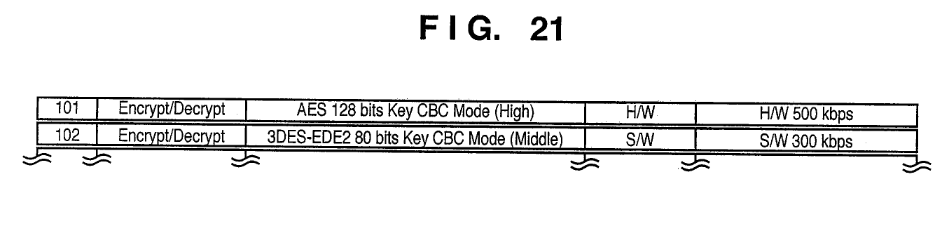

Similarly, the camera 10 also holds, in a memory 69, a correspondence table of encryption and authentication functions and index information. FIG. 21 is a table showing an example of the table held in the memory 69 by the camera 10. When the camera 10 executes encryption processing in the AES/128 bits key/CBC mode, an encryption and authentication function control unit 68 adds index information “101” to the processed digital data by looking up the correspondence table.

An example of index information is a numerical value such as “101”, but any unique code is available as long as the code can specify one record in the table shown in FIG. 20 or 21.

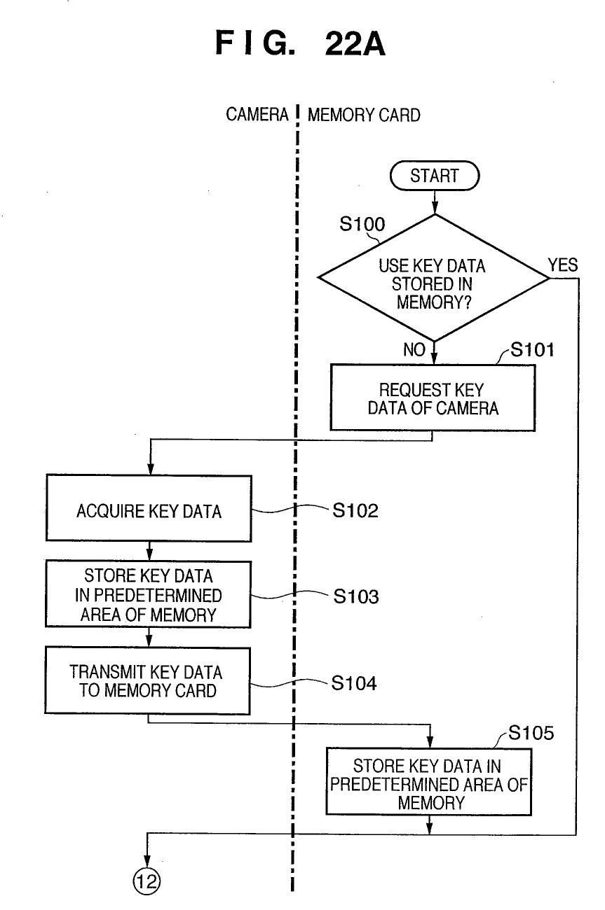

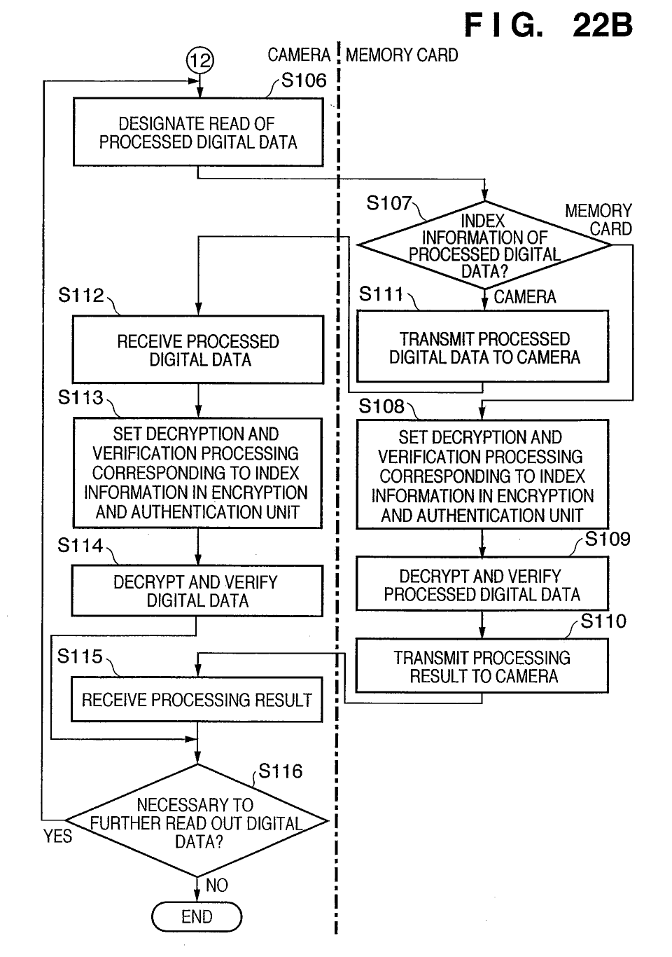

FIGS. 22A and 22B are flowcharts for explaining a digital data read operation after encryption and authentication processing according to the fifth embodiment. In the following description, the encryption and authentication unit 67 of the camera 10 and the encryption and authentication unit 22 of the memory card 20 execute decryption and verification processing.

In FIGS. 22A and 22B, processes (S170 to S175) associated with acquisition of key data correspond to those in steps S80 to S85 shown in FIG. 13A or 13B. Thus, a description of the processes in steps S170 to S175 will not be repeated.

A storage medium control unit 13 of the camera 10 instructs the memory card 20 to read out processed digital data (S176). From index information added to the processed digital data held in the memory 24, an encryption and authentication function control unit 23 of the memory card 20 determines which of the decryption and verification functions of the camera 10 and memory card 20 is to be utilized (S177). If the index information is “n” (on the assumption that the range of index information numbers corresponding to encryption and authentication functions of the memory card 20 is 1≦n≦100), the process advances to step S178. If the index information is “N” (on the assumption that the range of index information numbers corresponding to encryption and authentication functions of the camera 10 is 101≦N≦200), the process advances to step S170. When the camera 10 does not comprise the encryption and authentication unit 67, the process does not advance to step S170.

If the index information is “n”, the encryption and authentication function control unit 23 sets decryption and verification processing corresponding to the index information in the encryption and authentication unit 22 (S178), and processes the processed digital data using key data stored in the memory 24 (S179). Decryption and verification processing in step S179 is reverse to processing in step S91. For example, when processed digital data has been encrypted, it is decrypted into original digital data. When processed digital data has been signed, sign verification processing is executed to obtain a verification result.

The encryption and authentication function control unit 23 transmits the digital data (and the verification result as needed) obtained in step S179 to the camera 10 (S180). The storage medium control unit 13 of the camera 10 receives the digital data (and the verification result as needed) (S185). If the encryption and authentication function control unit 23 needs to further read out digital data, the process returns to step S176 (S186); if read of necessary digital data ends, the process ends.

If the index information is “N”, the encryption and authentication function control unit 23 of the memory card 20 transmits the processed digital data stored in the memory 24 to the camera 10 (S181). The storage medium control unit 13 of the camera 10 receives the processed digital data (S182). The encryption and authentication function control unit 68 sets decryption and verification processing corresponding to the index information in the encryption and authentication unit 67 (S183), and processes the processed digital data using key data stored in the memory 69 (S184). Decryption and verification processing in step S184 is reverse to processing in step S95.

If the storage medium control unit 13 needs to further read out digital data, the process returns to step S176 (S186); if read of necessary digital data ends, the process ends.

### Modification of Embodiment

The above-described embodiments have not referred to the list format. The list format is arbitrary such as the text format, binary format, ASN.1 format, and XML format as long as the camera 10 and memory card 20 can share the list.

In the third embodiment, the processing capabilities (speeds) of encryption and authentication functions supported by the camera 10 and memory card 20 have been exemplified as the criterion for determining whether to notify the memory card 20 of an encryption and authentication function applied to digital data. For example, when the memory 69 is available as the storage location of processed digital data, the determination criterion may include the transfer time of digital data from the camera 10 to the memory card 20. In this case, capability information prepared by adding the processing speed (time) of the encryption and authentication function of the memory card 20 to the digital data transfer time is compared with the processing speed (time) of the encryption and authentication function of the camera 10.

The above-described embodiments have described the method of externally acquiring key data for use in encryption and authentication processing. However, key data acquisition processing can be omitted by storing key data in the memory 69 of the camera 10 and the memory 24 of the memory card 20 in advance.

### Exemplary Embodiments

The present invention can be applied to a system constituted by a plurality of devices (e.g., host computer, interface, reader, printer) or to an apparatus comprising a single device (e.g., copying machine, facsimile machine).

Further, the present invention can provide a storage medium storing program code for performing the above-described processes to a computer system or apparatus (e.g., a personal computer), reading the program code, by a CPU or MPU of the computer system or apparatus, from the storage medium, then executing the program.

In this case, the program code read from the storage medium realizes the functions according to the embodiments.

Further, the storage medium, such as a floppy disk, a hard disk, an optical disk, a magneto-optical disk, CD-ROM, CD-R, a magnetic tape, a non-volatile type memory card, and ROM can be used for providing the program code.

Furthermore, besides above-described functions according to the above embodiments can be realized by executing the program code that is read by a computer, the present invention includes a case where an OS (operating system) or the like working on the computer performs a part or entire processes in accordance with designations of the program code and realizes functions according to the above embodiments.

Furthermore, the present invention also includes a case where, after the program code read from the storage medium is written in a function expansion card which is inserted into the computer or in a memory provided in a function expansion unit which is connected to the computer, CPU or the like contained in the function expansion card or unit performs a part or entire process in accordance with designations of the program code and realizes functions of the above embodiments.

In a case where the present invention is applied to the aforesaid storage medium, the storage medium stores program code corresponding to the flowcharts described in the embodiments.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application Nos. 2006-153987, filed Jun. 1, 2006 and 2007-135953, filed May 22, 2007, which are hereby incorporated by reference herein in their entirety.

What is claimed is:

1. A data processing apparatus, comprising:
an inquiry section, arranged to inquire a supported encryption and authentication function of a storage medium having an encryption and authentication section for digital data;
a notification section, arranged to select an encryption and authentication function to be applied to digital data based on a result of the inquiry, and notify the storage medium of a result of the selection; and
a transmitter, arranged to transmit the digital data and key data to the storage medium.

2. The apparatus according to claim 1, wherein said notification section selects at least one encryption and authentication function to be applied to the digital data based on the result of the inquiry.

3. The apparatus according to claim 1, wherein the encryption and authentication section of the storage medium performs processing corresponding to the notified encryption and authentication function on the digital data using the key data, and stores the processed digital data and the key data in a memory in correspondence with each other.

4. The apparatus according to claim 1, further comprising a generator arranged to generate the digital data.

5. The apparatus according to claim 1, further comprising a connection section arranged to connect or attach the storage medium.

6. A data processing apparatus, comprising:
a processor, arranged to perform digital data encryption and authentication processing;
a first transmitter, arranged to transmit key data to a storage medium having an encryption and authentication section which performs digital data encryption and authentication processing;
an inquiry section, arranged to inquire, of the storage medium, an encryption and authentication function and processing capability of the encryption and authentication section;
a selector, arranged to select an encryption and authentication function to be applied to digital data based on an encryption and authentication function of said processor and the encryption and authentication function of the encryption and authentication section that is acquired by the inquiry;
a determiner, arranged to compare a processing capability of said processor with the processing capability of the encryption and authentication section that is acquired by the inquiry, and determine which of said processor and the encryption and authentication section performs the digital data encryption and authentication processing; and
a second transmitter, arranged to transmit digital data having undergone the encryption and authentication processing by said processor to the storage medium or transmit a notification of the selected encryption and authentication function and digital data not subjected to the encryption and authentication processing to the storage medium so as to cause the encryption and authentication section to perform the digital data encryption and authentication processing.

7. A data storage device having a digital data encryption and authentication function, comprising:
a notification section, arranged to notify an external device of a supported encryption and authentication function in response to an inquiry from the external device;
a processor, arranged to perform encryption and authentication processing on digital data from the external device by using key data from the external device in accordance with selection by the external device in response to the notification; and
a memory, arranged to store the processed digital data and the key data in correspondence with each other.

8. The device according to claim 7, wherein said notification section sets, in the notification, information representing a processing capability of said processor.

9. A data storage device having a digital data encryption and authentication function, comprising:
a determiner, arranged to determine a device which has performed encryption and authentication processing on digital data, read of which from a memory is designated by an external device;
a processor, arranged to, when the device which has performed the encryption and authentication processing is the data storage device, read out the designated digital data and key data corresponding to the digital data from the memory, and decrypt and verify the digital data using the key data; and
a transmitter, arranged to, when the device which has performed the encryption and authentication processing is the data storage device, transmit the digital data decrypted and verified by said processor to the external device, or when the device which has performed the encryption and authentication processing is the external device, read out the designated digital data from the memory and transmit the designated digital data to the external device.

10. A data processing method, comprising the steps of:
inquiring a supported encryption and authentication function of a storage medium having an encryption and authentication section for digital data;
selecting an encryption and authentication function to be applied to digital data based on a result of the inquiry to notify the storage medium of a result of the selection; and
transmitting the digital data and key data to the storage medium.

11. A method of a data processing apparatus which has a processor arranged to perform digital data encryption and authentication processing, the method comprising the steps of:
transmitting key data to a storage medium having an encryption and authentication section which performs digital data encryption and authentication processing;
inquiring, of the storage medium, an encryption and authentication function and processing capability of the encryption and authentication section;
selecting an encryption and authentication function to be applied to digital data based on an encryption and authentication function of the processor and the encryption and authentication function of the encryption and authentication section that is acquired by the inquiry;
comparing a processing capability of the processor with the processing capability of the encryption and authentication section that is acquired by the inquiry to determine which of the processor and the encryption and authentication section performs the digital data encryption and authentication processing; and
transmitting digital data having undergone the encryption and authentication processing by the processor to the storage medium or transmitting a notification of the selected encryption and authentication function and digital data not subjected to the encryption and authentication processing to the storage medium so as to cause the encryption and authentication section to perform the digital data encryption and authentication processing.

12. A data processing method of a data storage device which has a digital data encryption and authentication function, the method comprising the steps of:
notifying an external device of a supported encryption and authentication function in response to an inquiry from the external device;
performing encryption and authentication processing on digital data from the external device by using key data from the external device in accordance with selection by the external device in response to the notification; and
storing the processed digital data and the key data in a memory in correspondence with each other.

13. A data processing method of a data storage device which has a digital data encryption and authentication function, the method comprising the steps of:
determining a device which has performed encryption and authentication processing on digital data, read of which from a memory is designated by an external device;
when the device which has performed the encryption and authentication processing is the data storage device, reading out the designated digital data and key data corresponding to the digital data from the memory to decrypt and verify the digital data using the key data;
when the device which has performed the encryption and authentication processing is the data storage device, transmitting the decrypted/verified digital data to the external device; and
when the device which has performed the encryption and authentication processing is the external device, reading out the designated digital data from the memory to transmit the designated digital data to the external device.

14. A computer-executable program stored on a computer-readable storage medium comprising program code causing a computer to perform a data processing method, the method comprising the steps of:
inquiring a supported encryption and authentication function of a storage medium having an encryption and authentication section for digital data;
selecting an encryption and authentication function to be applied to digital data based on a result of the inquiry to notify the storage medium of a result of the selection; and
transmitting the digital data and key data to the storage medium.

15. A computer-executable program stored on a computer-readable storage medium comprising program code causing a data processing apparatus which has a processor arranged to perform digital data encryption and authentication processing, to perform a data processing method, the method comprising the steps of:
transmitting key data to a storage medium having an encryption and authentication section which performs digital data encryption and authentication processing;
inquiring, of the storage medium, an encryption and authentication function and processing capability of the encryption and authentication section;
selecting an encryption and authentication function to be applied to digital data based on an encryption and authentication function of the processor and the encryption and authentication function of the encryption and authentication section that is acquired by the inquiry;
comparing a processing capability of the processor with the processing capability of the encryption and authentication section that is acquired by the inquiry to determine which of the processor and the encryption and authentication section performs the digital data encryption and authentication processing; and
transmitting digital data having undergone the encryption and authentication processing by the processor to the storage medium or transmitting a notification of the selected encryption and authentication function and digital data not subjected to the encryption and authentication processing to the storage medium so as to cause the encryption and authentication section to perform the digital data encryption and authentication processing.

16. A computer-executable program stored on a computer-readable storage medium comprising program code causing a data storage device which has a digital data encryption and authentication function, to perform a data processing method, the method comprising the steps of:
notifying an external device of a supported encryption and authentication function in response to an inquiry from the external device;
performing encryption and authentication processing on digital data from the external device by using key data from the external device in accordance with selection by the external device in response to the notification; and
storing the processed digital data and the key data in a memory in correspondence with each other.

17. A computer-executable program stored on a computer-readable storage medium comprising program code causing a data storage device which has a digital data encryption and authentication function, to perform a data processing method, the method comprising the steps of:
determining a device which has performed encryption and authentication processing on digital data, read of which from a memory is designated by an external device;
when the device which has performed the encryption and authentication processing is the data storage device, reading out the designated digital data and key data corresponding to the digital data from the memory to decrypt and verify the digital data using the key data;
when the device which has performed the encryption and authentication processing is the data storage device, transmitting the decrypted/verified digital data to the external device; and
when the device which has performed the encryption and authentication processing is the external device, reading out the designated digital data from the memory to transmit the designated digital data to the external device.

18. A computer-readable storage medium storing a computer-executable program causing a computer to perform a data processing method, the method comprising the steps of:
inquiring a supported encryption and authentication function of a storage medium having an encryption and authentication section for digital data;
selecting an encryption and authentication function to be applied to digital data based on a result of the inquiry to notify the storage medium of a result of the selection; and
transmitting the digital data and key data to the storage medium.

19. A computer-readable storage medium storing a computer-executable program causing a data processing apparatus which has a processor arranged to perform digital data encryption and authentication processing, to perform a data processing method, the method comprising the steps of:
transmitting key data to a storage medium having an encryption and authentication section which performs digital data encryption and authentication processing;
inquiring, of the storage medium, an encryption and authentication function and processing capability of the encryption and authentication section;
selecting an encryption and authentication function to be applied to digital data based on an encryption and authentication function of the processor and the encryption and authentication function of the encryption and authentication section that is acquired by the inquiry;
comparing a processing capability of the processor with the processing capability of the encryption and authentication section that is acquired by the inquiry to determine which of the processor and the encryption and authentication section performs the digital data encryption and authentication processing; and
transmitting digital data having undergone the encryption and authentication processing by the processor to the storage medium or transmitting a notification of the selected encryption and authentication function and digital data not subjected to the encryption and authentication processing to the storage medium so as to cause the encryption and authentication section to perform the digital data encryption and authentication processing.

20. A computer-readable storage medium storing a computer-executable program causing a data storage device which has a digital data encryption and authentication function, to perform a data processing method, the method comprising the steps of:
notifying an external device of a supported encryption and authentication function in response to an inquiry from the external device;
performing encryption and authentication processing on digital data from the external device by using key data from the external device in accordance with selection by the external device in response to the notification; and
storing the processed digital data and the key data in a memory in correspondence with each other.

21. A computer-readable storage medium storing a computer-executable program causing a data storage device which has a digital data encryption and authentication function, to perform a data processing method, the method comprising the steps of:
determining a device which has performed encryption and authentication processing on digital data, read of which from a memory is designated by an external device;
when the device which has performed the encryption and authentication processing is the data storage device, reading out the designated digital data and key data corresponding to the digital data from the memory to decrypt and verify the digital data using the key data;
when the device which has performed the encryption and authentication processing is the data storage device, transmitting the decrypted/verified digital data to the external device; and
when the device which has performed the encryption and authentication processing is the external device, reading out the designated digital data from the memory to transmit the designated digital data to the external device.
